(19) United States
(12) Patent Application Publication
(10) Pub. No.: US 2020/0082088 A1
(43) Pub. Date: Mar. 12, 2020

(54) User/Enterprise Data Protection Preventing Non-Authorized Firmware Modification

(71) Applicant: QUALCOMM Incorporated, San Diego, CA (US)

(72) Inventors: Baranidharan MUTHUKUMARAN, San Diego, CA (US); Ivan MCLEAN, San Diego, CA (US); Bollapragada V.J. MANOHAR, San Diego, CA (US); Vincent Pierre LE ROY, Austin, TX (US); Ashish GROVER, Carlsbad, CA (US)

(21) Appl. No.: 16/127,730

(22) Filed: Sep. 11, 2018

(51) Int. Cl. G06F 21/57; G06F 21/60; H04L 9/08; H04L 9/32

(52) U.S. Cl. CPC G06F 21/572; H04L 9/32; H04L 9/0877; G06F 21/602

(57) ABSTRACT

Various embodiments include methods and devices for implementing protection of data by preventing non-authorized firmware modification on a computing device. Embodiments may include measuring, by a software program, an image of a firmware update producing a measurement of the image of the firmware update, modifying a version identifier of a prior installed firmware producing a version identifier of the firmware update, applying a root key generation algorithm to the measurement of the image of the firmware update, the version identifier of the firmware update, and an enroll identity credential, generating an enroll encryption root key as an output of the root key generation algorithm, applying a seed key encryption algorithm to the enroll encryption root key and an enroll encryption seed key, and generating a sealed encryption seed key as an output of the seed key encryption algorithm.

### BACKGROUND

Computing devices typically store sensitive data owned by users or enterprises, but firmware or operating system software on the computing devices are owned by a computing device or secure module manufacturer. This leaves open the opportunity for the firmware or software owners to bypass security measures to compromise user or enterprise owned data on the computing devices without consent from the user or enterprise. For example, the firmware or software owners can load software to computing devices that removes the brute force attack mitigations. The firmware or software owners can disable secure boot/trust boot and/or load arbitrary firmware or software on the computing devices.

### SUMMARY

Various aspects include apparatuses and methods for protection of data by preventing non-authorized firmware modifications on a computing device. Various aspects may include measuring, by executing a software program, an image of a firmware update producing a measurement of the image of the firmware update, modifying a version identifier of a prior installed firmware producing a version identifier of the firmware update, applying a root key generation algorithm to the measurement of the image of the firmware update, the version identifier of the firmware update, and an enroll identity credential, generating an enroll encryption root key as an output of the root key generation algorithm, applying a seed key encryption algorithm to the enroll encryption root key and an enroll encryption seed key, and generating a sealed encryption seed key as an output of the seed key encryption algorithm.

Some aspects may further include receiving the version identifier of the prior installed firmware from a hardware memory of the computing device, and storing the version identifier of the firmware update to the hardware memory as a version identifier of a current installed firmware.

Some aspects may further include measuring, by a hardware component, an image of the current installed firmware producing a measurement of the image of the current installed firmware, applying the root key generation algorithm to the measurement of the image of the current installed firmware, the version identifier of the current installed firmware, and a verify identity credential, generating a verify encryption root key as an output of the root key generation algorithm, applying a seed key decryption algorithm to the verify encryption root key and the sealed encryption seed key, and generating a verify encryption seed key as an output of the seed key decryption algorithm. In some aspects, the enroll encryption seed key may be the same as the verify encryption seed key for the measurement of the image of the firmware update being the same as the measurement of the image of the current installed firmware, the version identifier of the firmware update may be the same as the version identifier of the current installed firmware, and the enroll identity credential may be the same as the verify identity credential.

Some aspects may further include decrypting data using the verify encryption seed key that is the same as the enroll encryption seed key.

In some aspects, the verify identity credential may include at least one of a user credential and an enterprise credential, and applying a root key generation algorithm to the measurement of the image of the current installed firmware, the version identifier of the current installed firmware, and a verify identity credential may include applying the root key generation algorithm to the measurement of the image of the current installed firmware, the version identifier of the current installed firmware, the verify identity credential, and at least one of a unique label, a secure user identifier, and a hardware unique key.

Some aspects may further include receiving an update signal. In some aspects, applying a root key generation algorithm to the measurement of the image of the firmware update, the version identifier of the firmware update, and an enroll identity credential may occur in response to receiving the update signal.

Some aspects may further include exposing the enroll encryption root key only to a secure component of the computing device.

In some aspects, the enroll identity credential may include at least one of a user credential and an enterprise credential, and applying a root key generation algorithm to the measurement of the image of the firmware update, the version identifier of the firmware update, and an enroll identity credential may include applying the root key generation algorithm to the measurement of the image of the firmware update, the version identifier of the firmware update, the enroll identity credential, and at least one of a unique label, a secure user identifier, and a hardware unique key.

Various aspects include computing devices having a processor configured to perform operations of any of the methods summarized above. Various aspects include computing devices having means for performing functions of any of the methods summarized above. Various aspects include a processor readable storage medium on which are stored processor-executable instructions configured to cause a processor to perform operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block diagram illustrating an example multicore processor suitable for implementing various embodiments.

FIG. 3 is a component block diagram illustrating an example secure component suitable for implementing various embodiments.

FIG. 4 is a component block diagram illustrating another example secure component suitable for implementing various embodiments.

FIG. 5 is a process flow diagram illustrating a method for user/enterprise data protection for preventing non-authorized firmware modification according to an embodiment.

FIG. 6 is a process flow diagram illustrating a method for user/enterprise data protection preventing non-authorized firmware modification according to an embodiment.

FIG. 7 is a process flow diagram illustrating a method for user/enterprise data protection preventing non-authorized firmware modification according to an embodiment.

FIG. 8 is a process flow diagram illustrating a method for user/enterprise data protection preventing non-authorized firmware modification according to an embodiment.

FIG. 9 is a component block diagram illustrating an example mobile computing device suitable for use with the various embodiments.

FIG. 10 is a component block diagram illustrating an example mobile computing device suitable for use with the various embodiments.

FIG. 11 is a component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices implementing such methods for user/enterprise data protection to prevent non-authorized firmware modification, thereby improving security of computing devices. Some embodiments may include generating and using an encryption root key for a firmware update and installation based on a user and/or enterprise credential (also referred to herein as an identity credential), a measurement of a firmware, and a computing device-assigned version number of the firmware. Some embodiments may include enrolling a firmware update for updating an installed firmware (referred to herein as a “prior installed firmware”) by generating the encryption root key using, at least, the user and/or enterprise credential, the measurement of the firmware update, and the computing device-assigned version number of the firmware update. Some embodiments may include assigning the computing device-assigned version number of the firmware update based on a version number of the prior installed firmware installed on the computing device prior to enrolling the firmware update. Some embodiments may include verifying the installed firmware updated (referred to herein as a “current installed firmware”) using, at least, the user and/or enterprise credential, a measurement of the current installed firmware, and the computing-device assigned version number of the current installed firmware. Some embodiments may include secure hardware components for deriving encryption root keys using, at least, the user and/or enterprise credential, the measurement of the firmware update or the current installed firmware, and the computing device-assigned version number of the firmware update or the current installed firmware.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

The term “firmware” is used herein to refer to software instructions stored in non-volatile memory that provide low-level control of a computing device, including providing the operating environment or operation system for the computing device.

User and/or enterprise data stored on a memory of a computing device may be encrypted and decrypted using an encryption seed key associated with a user and/or enterprise of the computing device. To protect the user and/or enterprise data from unauthorized access, the encryption seed key may be encrypted (also referred to herein as sealed or wrapped) using an encryption root key associated with a user and/or enterprise credential. To decrypt the user and/or enterprise data, the user and/or enterprise credential may be used to generate the encryption root key for decrypting (also referred to herein as unsealing or unwrapping) the encryption seed key. Unauthorized access to the user and/or enterprise data may be gained via firmware modification that thwarts the protection provided by the user and/or enterprise credential. For example, a firmware modification might be used to thwart protections against brute force guessing of the user and/or enterprise credential.

The various embodiments for user/enterprise data protection described herein may prevent unauthorized access to the user and/or enterprise data via firmware modification by enrolling a firmware update prior to installation, and verifying the installed firmware update, i.e., the current installed firmware. Enrolling and verifying a firmware update may be accomplished using, at least, the user and/or enterprise credential, a measurement of the firmware update before or after installation, and a computing device-assigned version number of the firmware update and the current installed firmware based on a version number of the prior installed firmware on the computing device. To enroll a firmware update prior to installation, a measurement of the firmware update, such as a hash of the code of the firmware update, may be taken by software executed on a secure processing unit of the computing device. This measurement of the firmware update may be taken in response to initialization of an installation process for the firmware update to the computing device. A version number of the firmware update may be assigned to the firmware update based on a modification of a version number of the prior installed firmware on the computing device, such as by incrementing a stored version number of the prior installed firmware on the computing device. The version number of the prior installed firmware on the computing device may be stored in memory on the computing device, such as in a hardware register or hardware fuse, and modified by a hardware component of the computing device. A secure hardware component, such as an encryption root key derivation component, may receive, at least, a user and/or enterprise credential (referred to herein in as an “enroll identity credential”), the measurement of the firmware update, and the version number of the firmware update. The secure component may generate an encryption root key (referred to herein as an “enroll encryption root key”) using, at least, the user and/or enterprise credential, the measurement of the firmware update, and the version number of the firmware update. Other inputs for generating the enroll encryption root key may include a hardware unique key of the computing device, a secure user identifier, and/or a unique label associated with a process of the computing device for use for the encryption root key. The enroll encryption root key may be used to encrypt (also referred to herein as seal or wrap) the encryption seed key (referred to herein as the “enroll encryption seed key”) for the user and/or enterprise data. The version number of the firmware update may be stored in memory of the computing device, such as in the hardware register or hardware fuse, as the version number of the current installed firmware.

Verifying the installed firmware update, i.e., the current installed firmware, may be implemented for execution of the current installed firmware to generate the encryption root key (referred to herein as the “verify encryption root key”) to decrypt (also referred to herein as unseal or unwrap) the sealed encryption seed key for access to the user and/or enterprise data. To verify the current installed firmware, a measurement of the current installed firmware, such as a hash of the code of the current installed firmware, may be taken by a hardware component of the computing device. This measurement of the current installed firmware may be taken during a secure boot process of the computing device. The secure hardware component, such as the encryption root key derivation component, may receive, at least, the user and/or enterprise credential (referred to herein as the “verify identity credential”), the measurement of the current installed firmware, and the version number of the current installed firmware. The secure component may generate an encryption root key (referred to herein as a “verify encryption root key”) using, at least, the user and/or enterprise credential, the measurement of the current installed firmware, and the version number of the current installed firmware. Other inputs for generating the verify encryption root key may include the hardware unique key of the computing device, the secure user identifier, and/or the unique label associated with the process of the computing device for use for the encryption root key. The verify encryption root key may be used to decrypt, unseal or unwrap, the sealed encryption seed key to produce the encryption seed key (referred to herein as the “verify encryption seed key”) for the user and/or enterprise data.

Generating the encryption root key to both encrypt and decrypt the encryption seed key, according to the embodiments described herein, may thwart the generation of encryption root keys for prior installed firmware versions by the current installed firmware, thereby preventing decryption (also referred to herein as unsealing or unwrapping) of the sealed encryption seed key and access to the encrypted user and/or enterprise data via a firmware update installation and execution. A mismatch between any of the inputs for generating the encryption root key during enrolling and during verifying may result in mismatched encryption root keys. Therefore, the verify encryption root key generated during verifying may not properly decrypt, unseal or unwrap, the sealed encryption seed key, resulting in an incorrect verify encryption seed key. Attempting to decrypt the encrypted user and/or enterprise data using the incorrect verify encryption seed key will fail to produce usable user and/or enterprise data. Thus, the various embodiments improve the operation of computing devices by providing greater security for user and/or enterprise data, and protect against a vulnerability not well addressed by other methods.

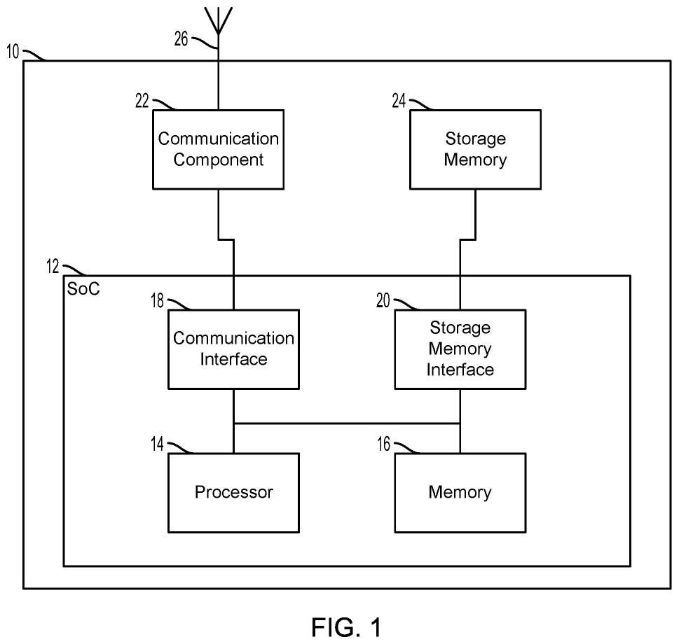

FIG. 1 illustrates a system including a computing device 10 suitable for use with various embodiments. The computing device 10 may include a system-on-chip (SoC) 12 with a processor 14, a memory 16, a communication interface 18, and a storage memory interface 20. The computing device 10 may further include a communication component 22, such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a secure processing unit (SPU), a subsystem processor of specific components of the computing device, such as an image processor for a camera subsystem or a display processor for a display, an auxiliary processor, a single-core processor, and a multicore processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

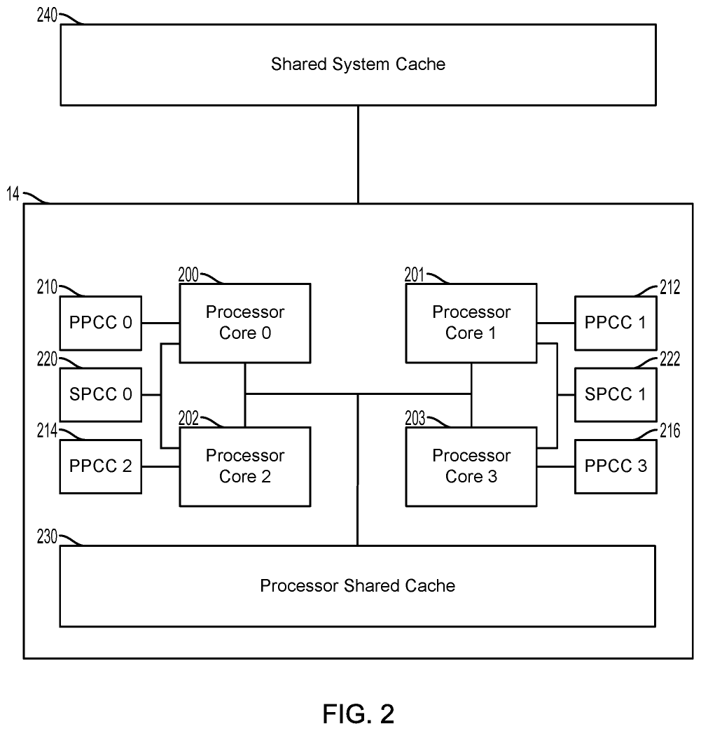

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 and/or the SoC 12 may be arranged differently and/or combined while still serving the functions of the various embodiments. The computing device 10 may not be limited to one of each of the components, and multiple instances of each component may be included in various configurations of the computing device 10.

FIG. 2 illustrates components of a computing device suitable for implementing an embodiment. The processor 14 may include multiple processor types, including, for example, a CPU and various hardware accelerators, such as a GPU, a DSP, an APU, an SPU subsystem processor, etc. The processor 14 may also include a custom hardware accelerator, which may include custom processing hardware and/or general purpose hardware configured to implement a specialized set of functions. The processors 14 may include any number of processor cores 200, 201, 202, 203. A processor 14 having multiple processor cores 200, 201, 202, 203 may be referred to as a multicore processor.

The processor 14 may have a plurality of homogeneous or heterogeneous processor cores 200, 201, 202, 203. A homogeneous processor may include a plurality of homogeneous processor cores. The processor cores 200, 201, 202, 203 may be homogeneous in that, the processor cores 200, 201, 202, 203 of the processor 14 may be configured for the same purpose and have the same or similar performance characteristics. For example, the processor 14 may be a general purpose processor, and the processor cores 200, 201, 202, 203 may be homogeneous general purpose processor cores. The processor 14 may be a GPU or a DSP, and the processor cores 200, 201, 202, 203 may be homogeneous graphics processor cores or digital signal processor cores, respectively. The processor 14 may be a custom hardware accelerator with homogeneous processor cores 200, 201, 202, 203.

A heterogeneous processor may include a plurality of heterogeneous processor cores. The processor cores 200, 201, 202, 203 may be heterogeneous in that the processor cores 200, 201, 202, 203 of the processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar embodiments, an SoC (for example, SoC 12 of FIG. 1) may include any number of homogeneous or heterogeneous processors 14. In various embodiments, not all off the processor cores 200, 201, 202, 203 need to be heterogeneous processor cores, as a heterogeneous processor may include any combination of processor cores 200, 201, 202, 203 including at least one heterogeneous processor core.

Each of the processor cores 200, 201, 202, 203 of a processor 14 may be designated a private processor core cache (PPCC) memory 210, 212, 214, 216 that may be dedicated for read and/or write access by a designated processor core 200, 201, 202, 203. The private processor core cache 210, 212, 214, 216 may store data and/or instructions, and make the stored data and/or instructions available to the processor cores 200, 201, 202, 203, to which the private processor core cache 210, 212, 214, 216 is dedicated, for use in execution by the processor cores 200, 201, 202, 203. The private processor core cache 210, 212, 214, 216 may include volatile memory as described herein with reference to memory 16 of FIG. 1.

Groups of the processor cores 200, 201, 202, 203 of a processor 14 may be designated a shared processor core cache (SPCC) memory 220, 222 that may be dedicated for read and/or write access by a designated group of processor core 200, 201, 202, 203. The shared processor core cache 220, 222 may store data and/or instructions, and make the stored data and/or instructions available to the group processor cores 200, 201, 202, 203 to which the shared processor core cache 220, 222 is dedicated, for use in execution by the processor cores 200, 201, 202, 203 in the designated group. The shared processor core cache 220, 222 may include volatile memory as described herein with reference to memory 16 of FIG. 1.

The processor 14 may include a shared processor cache memory 230 that may be dedicated for read and/or write access by the processor cores 200, 201, 202, 203 of the processor 14. The shared processor cache 230 may store data and/or instructions, and make the stored data and/or instructions available to the processor cores 200, 201, 202, 203, for use in execution by the processor cores 200, 201, 202, 203. The shared processor cache 230 may also function as a buffer for data and/or instructions input to and/or output from the processor 14. The shared cache 230 may include volatile memory as described herein with reference to memory 16 (FIG. 1).

Multiple processors 14 may access a shared system cache memory 240 that may be dedicated for read and/or write access by the processor cores 200, 201, 202, 203 of the multiple processors 14. The shared system cache 240 may store data and/or instructions, and make the stored data and/or instructions available to the processor cores 200, 201, 202, 203, for use in execution by the processor cores 200, 201, 202, 203. The shared system cache 240 may also function as a buffer for data and/or instructions input to and/or output from the multiple processors 14. The shared system cache 240 may include volatile memory as described herein with reference to memory 16 illustrated in FIG. 1.

In the example illustrated in FIG. 2, the processor 14 includes four processor cores 200, 201, 202, 203 (i.e., processor core 0, processor core 1, processor core 2, and processor core 3). In the example, each processor core 200, 201, 202, 203 is designated a respective private processor core cache 210, 212, 214, 216 (i.e., processor core 0 and private processor core cache 0, processor core 1 and private processor core cache 1, processor core 2 and private processor core cache 2, and processor core 3 and private processor core cache 3). The processor cores 200, 201, 202, 203 may be grouped, and each group may be designated a shared processor core cache 220, 222 (i.e., a group of processor core 0 and processor core 2 and shared processor core cache 0, and a group of processor core 1 and processor core 3 and shared processor core cache 1). For ease of explanation, the examples herein may refer to the four processor cores 200, 201, 202, 203, the four private processor core caches 210, 212, 214, 216, two groups of processor cores 200, 201, 202, 203, and the shared processor core cache 220, 222 illustrated in FIG. 2. However, the four processor cores 200, 201, 202, 203, the four private processor core caches 210, 212, 214, 216, two groups of processor cores 200, 201, 202, 203, and the shared processor core cache 220, 222 illustrated in FIG. 2 and described herein are merely provided as an example and in no way are meant to limit the various embodiments to a four-core processor system with four designated private processor core caches and two designated shared processor core caches 220, 222. The computing device 10, the SoC 12, or the processor 14 may individually or in combination include fewer or more than the four processor cores 200, 201, 202, 203 and private processor core caches 210, 212, 214, 216, and two shared processor core caches 220, 222 illustrated and described herein.

In various embodiments, a processor core 200, 201, 202, 203 may access data and/or instructions stored in the shared processor core cache 220, 222, the shared processor cache 230, and/or the shared system cache 240 indirectly through access to data and/or instructions loaded to a higher level cache memory from a lower level cache memory. For example, levels of the various cache memories 210, 212, 214, 216, 220, 222, 230, 240 in descending order from highest level cache memory to lowest level cache memory may be the private processor core cache 210, 212, 214, 216, the shared processor core cache 220, 222, the shared processor cache 230, and the shared system cache 240. In various embodiments, data and/or instructions may be loaded to a cache memory 210, 212, 214, 216, 220, 222, 230, 240 from a lower level cache memory and/or other memory (e.g., memory 16, 24 illustrated in FIG. 1) as a response to a miss the cache memory 210, 212, 214, 216, 220, 222, 230, 240 for a memory access request, and/or as a response to a prefetch operation speculatively retrieving data and/or instructions for future use by the processor core 200, 201, 202, 203. In various embodiments, the cache memory 210, 212, 214, 216, 220, 222, 230, 240 may be managed using an eviction policy to replace data and/or instructions stored in the cache memory 210, 212, 214, 216, 220, 222, 230, 240 to allow for storing other data and/or instructions. Evicting data and/or instructions may include writing the evicted data and/or instructions evicted from a higher level cache memory 210, 212, 214, 216, 220, 222, 230 to a lower level cache memory 220, 222, 230, 240 and/or other memory.

For ease of reference, the terms “hardware accelerator,” “custom hardware accelerator,” “multicore processor,” “processor,” and “processor core” may be used interchangeably herein. The descriptions herein of the illustrated computing device and its various components are only meant to be exemplary and in no way limiting. Several of the components of the illustrated example computing device may be variably configured, combined, and separated. Several of the components may be included in greater or fewer numbers, and may be located and connected differently within the SoC or separate from the SoC.

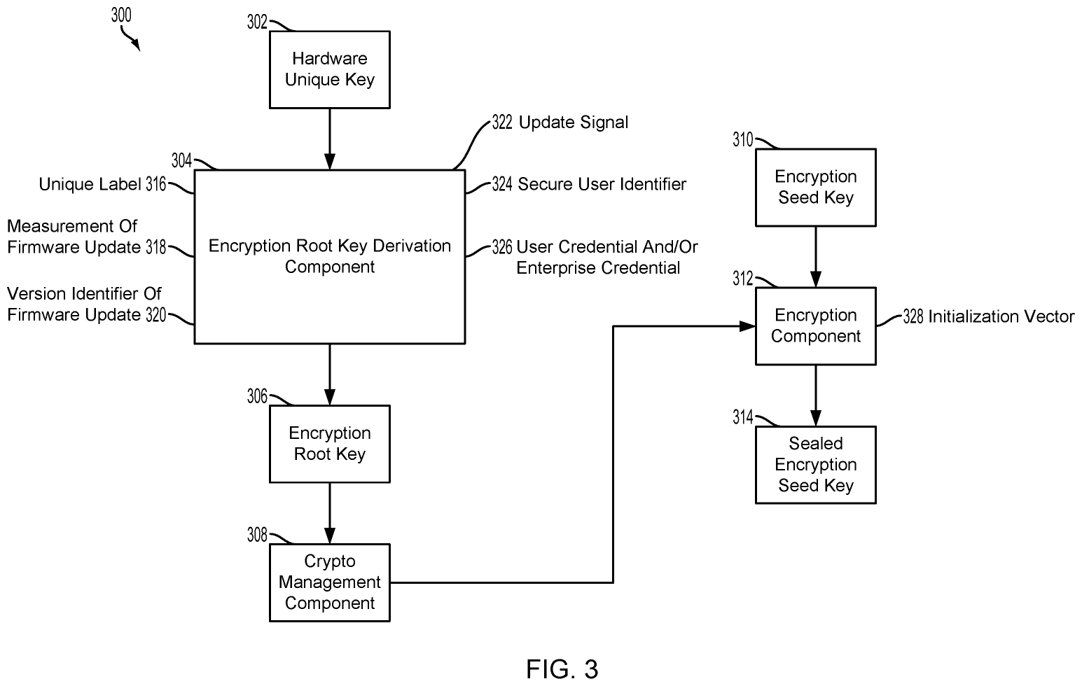

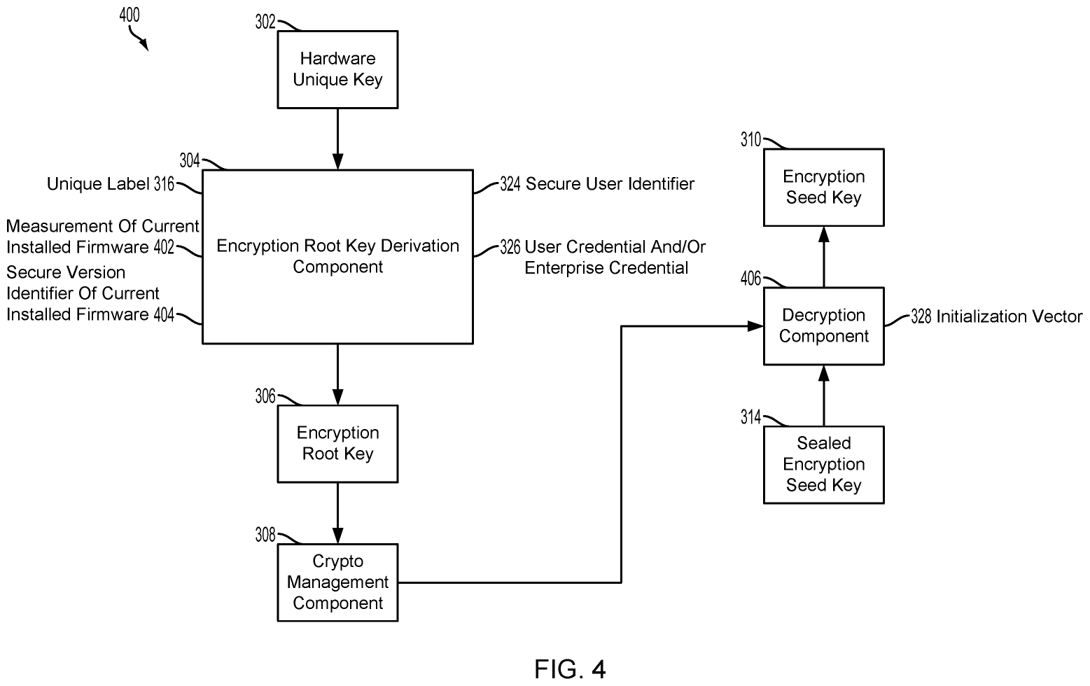

FIGS. 3 and 4 illustrate example secure components 300, 400 suitable for implementing various embodiments. With reference to FIGS. 1-4, a secure component 300 of the computing device (e.g., computing device 10 in FIG. 1) may be a processor (e.g., processor 14, 200, 201, 202, 203 in FIGS. 1 and 2), which may include an SPU. The secure component 300 may be an integral component of an SoC (e.g., SoC 12 in FIGS. 1 mad 2) or a component of the computing device separate from but communicatively connected to the SoC. A secure component 400 may be the same component as the secure component 300 of the computing device and/or a separate component of the computing device.

The secure component 300 may include various hardware components and may be configured to execute various software components. The secure component 300 may include a hardware crypto engine including an encryption root key derivation component 304, a crypto management component 308, and an encryption (and/or decryption) component 312. The secure component 300 may be a secure environment in which enroll encryption root keys are derived and used to encrypt, seal or wrap, an enroll encryption seed key.

The secure component 400 may include various hardware components and may be configured to execute various software components. The secure component 400 may include a hardware crypto engine including an encryption root key derivation component 304, a crypto management component 308, and an encryption (and/or decryption) component 406. The secure component 400 may be a secure environment in which verify encryption root keys are derived and used to decrypt, unseal or unwrap, a sealed encryption seed key to produce a verify encryption seed key.

In some embodiments in which the secure component 300, 400 is a single secure component 300, 400, the secure component 300, 400 may include any number of the hardware components. For example, the secure component 300, 400 may include the encryption root key derivation component 304. As another example, the secure component 300, 400 may include the crypto management component 308. As another example, the secure component 300, 400 may include an encryption and decryption component 312, 406. As another example, the secure component 300, 400 may include an encryption component 312 and a decryption component 406. As another example, the secure component 300, 400 may include may include the encryption root key derivation component 304, the crypto management component 308, and an encryption and decryption component 312, 406. As another example, the secure component 300, 400 may include the encryption root key derivation component 304, the crypto management component 308, an encryption component 312, and a decryption component 406.

An encryption seed key 310 may be associated with user and/or enterprise data stored on the computing device in a memory. The stored user and/or enterprise data may be encrypted, in which case the user and/or enterprise data may need to be decrypted to be used. The encryption seed key 310 may be the encryption key used to encrypt and/or decrypt the user and/or enterprise data. In some embodiments, the encryption seed key 310 may be stored on the computing device in a memory (e.g., memory 16, 24, 210, 212, 214, 216, 220, 222, 230, 240 in FIGS. 1 and 2) in a manner in which the encryption seed key 310 is encrypted, sealed or wrapped. The encrypted, sealed or wrapped, encryption seed key 310 may be referred to herein as the sealed encryption seed key 314. To use the encryption seed key 310 to encrypt and/or decrypt the user and/or enterprise data, the sealed encryption seed key 314 may need to be decrypted (also referred to herein as unsealed or unwrapped) to reveal the encryption seed key 310. Some embodiments described herein may detail encrypting the enroll encryption seed key 310 for enrolling a firmware update and decrypting the sealed encryption seed key 314 to produce the verify encryption seed key 310 for verifying the firmware update. In some embodiments, the verify encryption seed key 310 may be formatted as plaintext and the sealed encryption seed key 314 may be formatted as ciphertext.

In some embodiments, the secure component 300, 400 may also be configured to execute a secure boot process by retrieving a primary boot loader from an immutable memory (not shown), such as a read-only memory (ROM), and executing the primary boot loader. The secure component 300, 400 may be configured to measure firmware images retrieved from a memory (e.g., memory 16, 24, 210, 212, 214, 216, 220, 222, 230, 240 in FIGS. 1 and 2) (not shown) as a result of executing the primary boot loaded. Measurement of a firmware image may include applying a cryptographic hash function to the firmware image that may produce a hash value for the firmware image, such as a bit string, which may be used to represent and/or identify the firmware image. A secure boot may be a part of a process to update a firmware.

The secure component 300 illustrated in FIG. 3 may be an example of the secure component 300 configured to enroll a firmware update by generating an enroll encryption root key 306 that may be used to encrypt, seal or wrap, the enroll encryption seed key 310. The encryption root key derivation component 304 may be configured to generate the enroll encryption root key 306 for enrolling the firmware update. A firmware update may be initiated on the computing device and cause an update signal 322 to be received at the enroll encryption root key derivation component 304. The update signal 322 may prompt the enroll encryption root key derivation component 304 to initiate enrolling the firmware update.

As part of enrolling the firmware update, a firmware update measurement software (not shown) may be executed by the secure component 300 or another component. The firmware update measurement software may measure an image of the firmware update to generate a measurement of the firmware update 318 that may be used to generate the enroll encryption root key 306, which may be used to verify the current installed firmware after the firmware update is installed. The measurement of the firmware update 318 may be a representation of the image of the firmware update in a form different from the image of the firmware update. As an example, the firmware update measurement software may measure the firmware update by applying a cryptographic hash function to the image of the firmware update. The result of the application of the cryptographic hash function to the image of the firmware update may be a representation of the firmware update, such as a bit string. The measurement of the firmware update 318 may be received by the encryption root key derivation component 304 from the firmware update measurement software.

The encryption root key derivation component 304 may also receive a version identifier of the firmware update 320. The version identifier of the firmware update 320 may be a modified version identifier of a prior installed firmware. The version identifier of the prior installed firmware may be stored in a memory of the computing device (not shown), such as in a hardware register or hardware fuse. In some embodiments, the memory storing the version identifier of the prior installed firmware may be integral to or separate from the secure component 300. The secure component 300 may be configured to modify the version identifier of the prior installed firmware to generate the version identifier of the firmware update 320 using any arithmetic, logical, and/or bitwise operations. Using a modified version of the version identifier of the prior installed firmware increases the difficulty for an attacker to replicate previous version identifiers of the prior installed firmware to be able to access and modify the current installed firmware. For example, the secure component 300 may increment the version identifier of the prior installed firmware to generate the version identifier of the firmware update 320. The descriptions herein of the modification of the version identifier of the prior installed firmware as an increment operation are provided as examples for ease of explanation and clarity, but other ways of modifying version identifiers may be used and the descriptions using the example of incrementing the identifier are not intended to limit the scope of the claims. In some embodiments, the encryption root key derivation component 304 may receive the version identifier of the prior installed firmware and increment the version identifier of the prior installed firmware to generate the version identifier of the firmware update 320.

The encryption root key derivation component 304 may also receive various other secure firmware enroll parameters for generating the enroll encryption root key 306. Such secure firmware enroll parameters may include a unique label 316, a secure user identifier 324, a user and/or enterprise credential 326 (also referred to herein as an enroll identity credential 326), and/or a hardware unique key 302. The unique label 316 may be a value of any format configured to indicate a specific use of the firmware by the computing device. The firmware update may be configured to update a firmware for a specific component of the computing device, or even a specific function of the specific component, relevant to the firmware of the firmware update. The unique label 316 may be associated with the firmware of the firmware update and its enroll encryption root key 306. Such an association may cause a change in the specific component of the computing device, or the specific function of the specific component, relevant to the firmware of the firmware update to expressed or executed for the specific use of the firmware by the computing device.

The secure user identifier 324 may be a value of any format configured to identify a specific user profile of the computing device. The computing device may implement various user profiles configured with different permissions for use of a specific component of the computing device, or even a specific function of the specific component, relevant to the firmware of the firmware update. The secure user identifier 324 may be associated with the firmware of the firmware update and its enroll encryption root key 306. Such an association may cause a change in the specific component of the computing device, or the specific function of the specific component, relevant to the firmware of the firmware update to expressed or executed for the associated user profile of the secure user identifier 324, but potentially not for another user profile of the computing device.

The user and/or enterprise credential 326 may be a value of any format configured validate identity of a user and/or enterprise of the computing device. For example, the user and/or enterprise credential 326 may be a value such as a passcode in any format (e.g., a result of interaction with a button, touchscreen, microphone, camera, biometric sensor, etc.) used to login to a user and/or enterprise profile, used to verify identity of a user and/or enterprise, used to permit changes to be executed on the computing device, or a representation of a successful validation thereof. The computing device may implement security protocols to prevent and grant access for use of a specific component of the computing device, or even a specific function of the specific component, relevant to the firmware of the firmware update. The user and/or enterprise credential 326 may be associated with the firmware of the firmware update and its enroll encryption root key 306. Such an association may cause a change in the specific component of the computing device, or the specific function of the specific component, relevant to the firmware of the firmware update to expressed or executed for the associated validated identity of a user and/or enterprise of the computing device of the user and/or enterprise credential 326. Such an association may be referred to binding the firmware state or version to the user and/or enterprise credential 326.

In some embodiments, the secure component 300, including the encryption root key derivation component 304 may not generate the enroll encryption root key 306 without a validated user and/or enterprise credential 326. Failure to generate the enroll encryption root key 306 may prevent the installation and/or use of the firmware of the firmware update. As such, changes to a firmware may be prevented if a correct user and/or enterprise credential 326 is not provided. In some embodiments, the user and/or enterprise credential 326 may be separate credentials for a user of the computing device and an enterprise using, owning, issuing, and/or controlling hardware and/or software components of the computing device. In some embodiments, only one of or both of the user credential 326 and the enterprise credential 326 may be required to implement a firmware update.

The hardware unique key 302 may be a value of any format configured to indicate a specific computing device or component of the computing device. The firmware update may be configured to update a firmware for a specific component of the computing device, or even a specific function of the specific component, relevant to the firmware of the firmware update. The hardware unique key 302 may be associated with the firmware of the firmware update and its enroll encryption root key 306. Such an association may cause a change in the specific component of the computing device, or the specific function of the specific component, relevant to the firmware of the firmware update to be expressed or executed for the specific computing device or component of the computing device. This association may prevent an attempt to modify an identification of the computing device or component of the computing device to access the computing device.

The encryption root key derivation component 304 may apply a root key generation algorithm to any combination of the secure firmware enroll parameters for generating the enroll encryption root key 306, including at least the measurement of the firmware update 318, the version identifier of the firmware update 320, and the user and/or enterprise credential 326. The encryption root key derivation component 304 may apply the root key generation algorithm to any combination of the secure firmware enroll parameters for generating the enroll encryption root key 306, further including the unique label 316, the secure user identifier 324, and/or the hardware unique key 302. The encryption root key derivation component 304 may generate and output the enroll encryption root key 306. The enroll encryption root key 306 may be stored in a memory of the computing device (not shown), such as a hardware register, that may be integral to or separate from the secure component 300.

The crypto management component 308 may be configured to manage access to the enroll encryption root key 306. The crypto management component 308 may be configured such that the enroll encryption root key 306 is never exposed to software outside of secure component 300.

The encryption component 312 may be configured to encrypt, seal or wrap, the enroll encryption seed key 310 and generate a sealed encryption seed key 314. The encryption component 312 may receive the enroll encryption seed key 310 and the enroll encryption root key 306 via access granted by the crypto management component 308. In some embodiments, the encryption component 312 may also receive an initialization vector 328. The encryption component 312 may apply a seed key encryption algorithm to the enroll encryption root key 306 and the enroll encryption seed key 310, and/or the initialization vector 328 to encrypt, seal or wrap, the enroll encryption seed key 310 and generate the sealed encryption seed key 314. In some embodiments, the encryption component 312 may generate a message authentication code (or tag) to confirm authenticity if the enroll encryption seed key 310.

The secure component 400 illustrated in FIG. 4 may be an example of the secure component 400 configured to verify current installed firmware by generating a verify encryption root key 306 that may be used to decrypt, unseal or unwrap, the sealed encryption seed key 314 to produce the verify encryption seed key 310. The encryption root key derivation component 304 may be configured to generate the verify encryption root key 306 for verifying the current installed firmware. The current installed firmware may be firmware of the firmware update and enrolled by the secure component 300 as described with reference to FIG. 3. The installation of the firmware may include storing the firmware to a memory (e.g., memory 16, 24, 210, 212, 214, 216, 220, 222, 230, 240 in FIGS. 1 and 2) (not shown). Verification of the current installed firmware may be implemented for any attempt to load or execute the current installed firmware.

As part of verifying the current installed firmware, the primary boot loader executed, for example, by the secure component 400, may measure an image of the current installed firmware. The current installed firmware measurement may be implemented by hardware components, such as the secure component 400. The current installed firmware measurement may measure an image of the current installed firmware to generate a measurement of the current installed firmware 402 that may be used to generate the verify encryption root key 306, which may be used to verify the current installed firmware after the firmware update is installed. The measurement of the current installed firmware 402 may be a representation of the image of the current installed firmware in a form different from the image of the current installed firmware. For example, the hardware components may measure the current installed firmware by applying a cryptographic hash function to the image of the current installed firmware. The result of the application of the cryptographic hash function to the image of the current installed firmware may be a representation of the current installed firmware, such as a bit string. The measurement of the current installed firmware 402 may be received by the encryption root key derivation component 304 from the hardware components.

The encryption root key derivation component 304 may also receive a secure version identifier of the current installed firmware 404. The secure version identifier of the current installed firmware 404 may be the version identifier of the firmware update 320 as described herein with reference to FIG. 3. The secure version identifier of the current installed firmware 404 may be stored in a memory of the computing device (not shown), such as in a hardware register or hardware fuse. In some embodiments, the memory storing the secure version identifier of the current installed firmware 404 may be integral to or separate from the secure component 400.

The encryption root key derivation component 304 may also receive various other secure firmware verify parameters for generating the verify encryption root key 306. Such secure firmware verify parameters may include a unique label 316, a secure user identifier 324, a user and/or enterprise credential 326 (referred to herein as a verify identity credential 326), and/or a hardware unique key 302 as described with reference to FIG. 3. The unique label 316, a secure user identifier 324, a user and/or enterprise credential 326, and/or a hardware unique key 302 may be associated with the current installed firmware as the current installed firmware was previously the firmware of the firmware update.

The encryption root key derivation component 304 may apply a root key generation algorithm to any combination of the secure firmware verify parameters for generating the verify encryption root key 306, including at least the measurement of the current installed firmware 402, the secure version identifier of the current installed firmware 404, and the user and/or enterprise credential 326. The encryption root key derivation component 304 may apply the root key generation algorithm to any combination of the secure firmware verify parameters for generating the verify encryption root key 306, further including the unique label 316, the secure user identifier 324, and/or the hardware unique key 302. The encryption root key derivation component 304 may generate and output the verify encryption root key 306. The verify encryption root key 306 may be stored in a memory of the computing device (not shown), such as a hardware register, that may be integral to or separate from the secure component 300. The enroll encryption root key 306 and verify encryption root key 306 generated by the secure component 300 and the secure component 400 should be the same for the same enroll and verify parameters, and the verify encryption root key 306 should be able to be used to properly decrypt, unseal or unwrap, the sealed encryption seed key 314. To produce the same encryption root key 306, the measurement of the firmware update 318 should be the same as the measurement of the current installed firmware 402, the version identifier of the firmware update 320 should be the same as the secure version identifier of the current installed firmware 404, and the user and/or enterprise credential 326 should be the same. Also, any of the other parameters used, including the unique label 316, the secure user identifier 324, and/or the hardware unique key 302, should be the same.

The crypto management component 308 may be configured to manage access to the verify encryption root key 306. The crypto management component 308 may be configured such that the verify encryption root key 306 is never exposed to software outside of secure component 400.

The decryption component 406 may be configured to decrypt, unseal or unwrap, the sealed encryption seed key 314 and generate the verify encryption seed key 310. The decryption component 406 may receive the sealed encryption seed key 314 and the verify encryption root key 306 via access granted by the crypto management component 308. In some embodiments, the decryption component 406 may also receive an initialization vector 328. The decryption component 406 may apply a seed key decryption algorithm to the verify encryption root key 306 and the sealed encryption seed key 314, and/or the initialization vector 328 to decrypt, unseal or unwrap, the sealed encryption seed key 314 and generate the verify encryption seed key 310. In some embodiments, the encryption component 312 may generate a message authentication code (or tag) to confirm authenticity of the sealed encryption seed key 314.

When all of the verify parameters input to the encryption root key derivation component 304 are correct for the current installed firmware, the generated verify encryption root key 306 should be correct. Using the correct verify encryption root key 306 and the sealed encryption seed key 314, the decryption component 406 should be able to generate the correct verify encryption seed key 310. In other words, the verify encryption seed key 310 should be the same as the enroll encryption seed key 310. The computing device may use the correct verify encryption seed key 310 to decrypt user and/or enterprise data stored in the memory of the computing device.

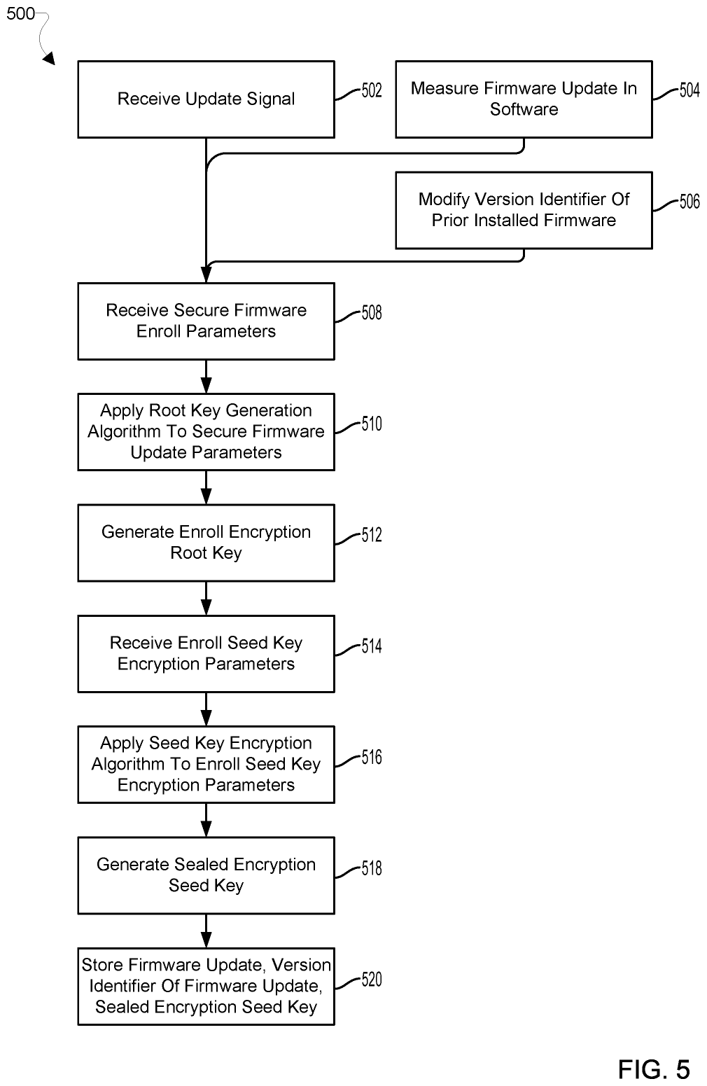

FIG. 5 illustrates a method 500 for user and/or enterprise data protection preventing non-authorized firmware modification according to an embodiment. The method 500 may be implemented in a computing device (e.g., computing device 10 in FIG. 1), in software executing in a processor (e.g., processor 14, 200, 201, 202, 204 in FIGS. 1 and 2, secure component 300, 400 in FIGS. 3 and 4), in general purpose hardware, in dedicated hardware (e.g., secure component 300, 400, encryption root key derivation component 304, crypto management component 308, and encryption and/or decryption component 312, 406 in FIGS. 3 and 4), or in a combination of a software-configured processor and dedicated hardware, such as a processor executing software within a secure firmware update system that includes other individual components (e.g., memory 16, 24 illustrated in FIG. 1, cache memory 210, 212, 214, 216, 220, 222, 230, 240 illustrated in FIG. 2), and various memory/cache controllers. In order to encompass the alternative configurations enabled in various embodiments, the hardware implementing the method 500 is referred to herein as a “processing device.”

In block 502, the processing device may receive an update signal. The update signal may be sent to the processing device from a component of the computing device and may be configured to indicate that the computing device is processing the update and installation of a firmware update. The update signal may prompt the processing device to initiate an enroll function of the firmware update, configured to encrypt, seal or wrap, an enroll encryption seed key in a manner that associates the enroll encryption seed key with the firmware update.

In block 504, the processing device may measure a firmware update using firmware update measurement software. The firmware update may be represented by an image of the firmware executable code of the firmware update. The processing device may execute the firmware update measurement software to applying a cryptographic hash function to the image of the firmware update. The result of the application of the cryptographic hash function to the image of the firmware update may be a representation of the firmware update, such as a bit string.

In block 506, the processing device may modify a version identifier of a prior installed firmware. The processing device may retrieve the version identifier of the prior installed firmware from a memory of the computing device, such as a hardware register or a hardware fuse. In some embodiments, the memory storing the version identifier of the prior installed firmware may be integral to or separate from the processing device. The processing device may be configured to modify the version identifier of the prior installed firmware using any arithmetic, logical, and/or bitwise operations. In some embodiments, the processing device may increment the version identifier of the prior installed firmware to generate a version identifier of the firmware update. Modifying the version identifier of the prior installed firmware may result in a version identifier of the firmware update, as this version identifier may be associated with the firmware for generating an enroll encryption root key for use in encryption of an enroll encryption seed key and later verification of the firmware update once installed. In some embodiments, the operations of modifying the version identifier of the prior installed firmware in block 506 may be performed after receiving secure firmware enroll parameters in block 508.

In block 508, the processing device may receive secure firmware enroll parameters. In some embodiments the secure firmware enroll parameters may include at least the measurement of the firmware update, the version identifier of the firmware update, and a user and/or enterprise credential (also referred to herein as an “enroll identity credential”), as previously described with reference to FIGS. 3 and 4. In some embodiments, the version identifier of the firmware update may be substituted for the version identifier of the prior installed firmware in which the modification of the version identifier of the prior installed firmware in block 506 occurs after receiving the secure firmware enroll parameters in block 508. In some embodiments, the secure firmware enroll parameters may include any combination of a unique label, a secure user identifier, and/or a hardware unique key, as described further herein with reference to FIGS. 3 and 4.

In block 510, the processing device may apply a root key generation algorithm to the secure firmware enroll parameters. The root key generation algorithm may be configured to generate an enroll encryption root key, which may be associated with the firmware of the firmware update. The enroll encryption root key may be configured to be used for encryption of an enroll encryption seed key and later verification of the firmware update once installed on the computing device.

In block 512, the processing device may generate the enroll encryption root key. The enroll encryption root key may be generated as a result of the application of the root key generation algorithm to the secure firmware enroll parameters in block 510. The enroll encryption root key may be stored in a memory of the computing device, such as a hardware register, that may be integral to or separate from the processing device.

In block 514, the processing device may receive enroll seed key encryption parameters. The enroll seed key encryption parameters may include at least an enroll encryption seed key and the enroll encryption root key, as described with reference to FIGS. 3 and 4. In some embodiments, the enroll seed key encryption parameters may also include an initialization vector, as described with reference to FIGS. 3 and 4. In some embodiments, the encryption seed key (the enroll encryption seed key and the verify encryption seed key when they are the same) may be configured for use in encrypting and decrypting user and/or enterprise data stored in a memory of the computing device. To protect the user and/or enterprise data, the user and/or enterprise data may be encrypted using the enroll encryption seed key. However, the encryption seed key may be stored in a memory of the computing device, and an exploitation of the computing device may allow an attacker access to and use of the encryption seed key. To protect the enroll encryption seed key, the enroll encryption seed key may be encrypted, sealed or wrapped, using the enroll encryption root key as a parameter to an encryption algorithm. As discussed herein, the enroll encryption root key may be generated based on a variety of secure firmware enroll parameters that makes it difficult to crack the enroll encryption root key.

In block 516, the processing device may apply a seed key encryption algorithm to the enroll seed key encryption parameters. The seed key encryption algorithm may be configured to generate an encrypted, sealed or wrapped, encryption seed key. The sealed encryption seed key may be associated with the firmware of the firmware update by virtue of the encryption root key associated with the firmware of the firmware update being an enroll seed key encryption parameter.

In block 518, the processing device may generate the sealed encryption seed key. The sealed encryption seed key may be generated as a result of the application of the seed key encryption algorithm to the enroll seed key encryption parameters in block 516. The sealed encryption seed key may be stored in a memory of the computing device. While an exploitation of the computing device may allow an attacker access to the sealed encryption seed key, use of the sealed encryption seed key may be thwarted because the attacker is not able to decrypt, unseal or unwrap the sealed encryption seed key. Without the encryption seed key, the attacker cannot decrypt the user and/or enterprise data stored in the memory of the computing device.

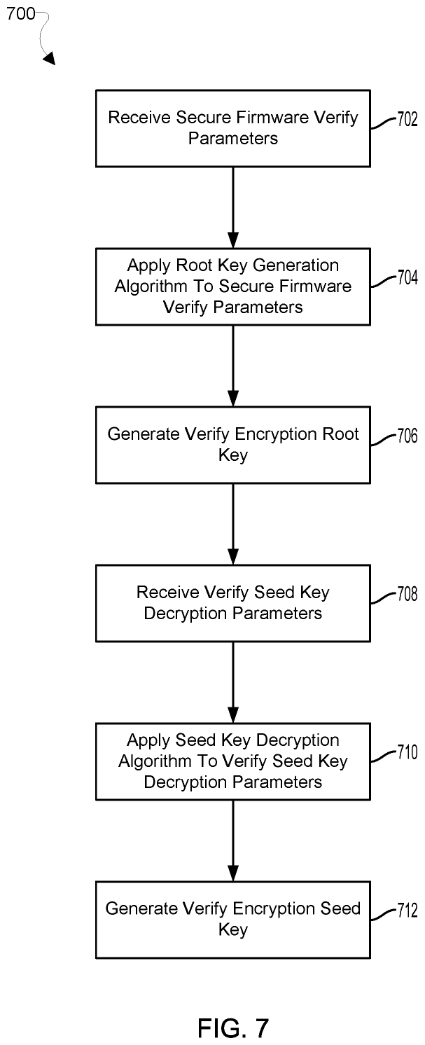

In block 520, the processing device may store the firmware of the firmware update, the version identifier of the firmware update, and the sealed encryption seed key. In some embodiments, the firmware of the firmware update may be stored in a memory of the computing device accessible by the processing device for retrieval and loading during a secure boot by a primary boot loader. Again, the stored firmware of the firmware update is referred to herein as the current installed firmware. In some embodiments, the version identifier of the firmware update may be stored in a hardware memory, such as a hardware register or a hardware fuse, that may be accessible by the processing device, and may be integral to or separate from the processing device. The stored version identifier of the firmware update may be referred to herein as the version identifier of the current installed firmware. In some embodiments, the sealed encryption seed key may be stored in a memory of the computing device accessible by the processing device for retrieval and verification during a verify process, such as described in method 700 with reference to FIG. 7.

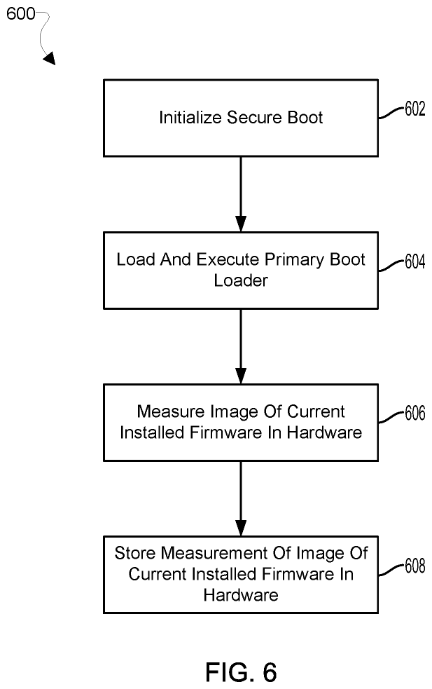

FIG. 6 illustrates a method 600 for user and/or enterprise data protection preventing non-authorized firmware modification according to an embodiment. The method 600 may be implemented in a computing device (e.g., computing device 10 in FIG. 1), in software executing in a processor (e.g., processor 14, 200, 201, 202, 204 in FIGS. 1 and 2, secure component 300, 400 in FIGS. 3 and 4), in general purpose hardware, in dedicated hardware (e.g., secure component 300, 400, encryption root key derivation component 304, crypto management component 308, and encryption and/or decryption component 312, 406 in FIGS. 3 and 4), or in a combination of a software-configured processor and dedicated hardware, such as a processor executing software within a secure firmware update system that includes other individual components (e.g., memory 16, 24 illustrated in FIG. 1, cache memory 210, 212, 214, 216, 220, 222, 230, 240 illustrated in FIG. 2), and various memory/cache controllers. In order to encompass the alternative configurations enabled in various embodiments, the hardware implementing the method 600 is referred to herein as a “processing device.”

In block 602, the processing device may initialize a secure boot. In some embodiments the secure boot may be implemented in a secure execution environment and use boot code stored in immutable memory, such as a ROM, so that it is known that the boot code is not compromised.

In block 604, the processing device may load and execute a primary boot loader. The primary boot loader may include boot code that is retrieved from the immutable memory, and may be configured to retrieve images of installed firmware, such as the prior installed firmware and/or the current installed firmware, for activating hardware components of the computing device. In some embodiments, the installed firmware may be stored in protected memory with limited or no access to the installed firmware from outside of the secure execution environment. Even so, the installed firmware may be vulnerable to attacks that attempt to overwrite the installed firmware using a firmware update technique.

In block 606, the processing device may measure the image of the current installed firmware that was retrieved by the primary boot loader. The operations in block 606 may be performed by the processing device using hardware configured to measure the image of the current installed firmware. The measurement of the current installed firmware 402 may be a representation of the image of the current installed firmware in a form different from the image of the current installed firmware. The processing device may measure the current installed firmware, for example, by applying a cryptographic hash function to the image of the current installed firmware. The result of the application of the cryptographic hash function to the image of the current installed firmware may be a representation of the current installed firmware, such as a bit string.

In block 608, the processing device may store the measurement of the current installed firmware in a hardware memory of the computing device, such as a hardware register.

FIG. 7 illustrates a method 700 for user and/or enterprise data protection preventing non-authorized firmware modification according to an embodiment. The method 700 may be implemented in a computing device (e.g., computing device 10 in FIG. 1), in software executing in a processor (e.g., processor 14, 200, 201, 202, 204 in FIGS. 1 and 2, secure component 300, 400 in FIGS. 3 and 4), in general purpose hardware, in dedicated hardware (e.g., secure component 300, 400, encryption root key derivation component 304, crypto management component 308, and encryption and/or decryption component 312, 406 in FIGS. 3 and 4), or in a combination of a software-configured processor and dedicated hardware, such as a processor executing software within a secure firmware update system that includes other individual components (e.g., memory 16, 24 illustrated in FIG. 1, cache memory 210, 212, 214, 216, 220, 222, 230, 240 illustrated in FIG. 2), and various memory/cache controllers. In order to encompass the alternative configurations enabled in various embodiments, the hardware implementing the method 700 is referred to herein as a “processing device.”

In block 702, the processing device may receive secure firmware verify parameters. In some embodiments the secure firmware verify parameters may include at least the measurement of the current installed firmware, the secure version identifier of the current installed firmware, and the user and/or enterprise credential (also referred to herein as a verify identity credential), as described further herein with reference to FIGS. 3 and 4. In some embodiments, the secure firmware verify parameters may include any combination of a unique label, a secure user identifier, and/or a hardware unique key, as described further herein with reference to FIGS. 3 and 4.

In block 704, the processing device may apply a root key generation algorithm to the secure firmware verify parameters. The root key generation algorithm may be configured to generate a verify encryption root key, which may be associated with the current installed firmware. The verify encryption root key may be configured to be used for decryption of a sealed encryption seed key and verification of the current installed firmware on the computing device.

In block 706, the processing device may generate the verify encryption root key. The verify encryption root key may be generated as a result of the application of the root key generation algorithm to the secure firmware verify parameters in block 704. The verify encryption root key may be stored in a memory of the computing device, such as a hardware register, that may be integral to or separate from the processing device.

In block 708, the processing device may receive verify seed key decryption parameters. The verify seed key decryption parameters may include at least a sealed encryption seed key and the verify encryption root key as described with reference to FIGS. 3 and 4. In some embodiments, the verify seed key decryption parameters may also include an initialization vector as described with reference to FIGS. 3 and 4.

In block 710, the processing device may apply a seed key decryption algorithm to the verify seed key decryption parameters. The seed key decryption algorithm may be configured to generate a decrypted, unsealed or unwrapped, verify encryption seed key. The verify encryption seed key may be associated with the current installed firmware by virtue of the encryption root key associated with the current installed firmware being a seed key decryption parameter.

In block 712, the processing device may generate the verify encryption seed key. The verify encryption seed key may be generated as a result of the application of the seed key decryption algorithm to the verify seed key decryption parameters in block 710. The verify encryption seed key may be stored in a memory of the computing device.

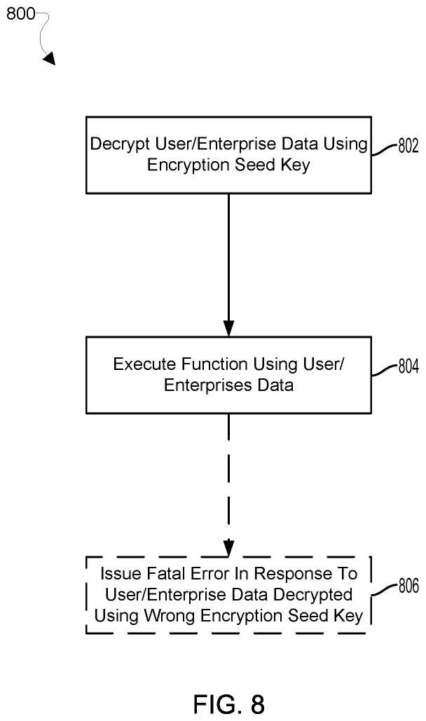

FIG. 8 illustrates a method 800 for user and/or enterprise data protection preventing non-authorized firmware modification according to an embodiment. The method 800 may be implemented in a computing device (e.g., computing device 10 in FIG. 1), in software executing in a processor (e.g., processor 14, 200, 201, 202, 204 in FIGS. 1 and 2, secure component 300, 400 in FIGS. 3 and 4), in general purpose hardware, in dedicated hardware (e.g., secure component 300, 400, encryption root key derivation component 304, crypto management component 308, and encryption and/or decryption component 312, 406 in FIGS. 3 and 4), or in a combination of a software-configured processor and dedicated hardware, such as a processor executing software within a secure firmware update system that includes other individual components (e.g., memory 16, 24 illustrated in FIG. 1, cache memory 210, 212, 214, 216, 220, 222, 230, 240 illustrated in FIG. 2), and various memory/cache controllers. In order to encompass the alternative configurations enabled in various embodiments, the hardware implementing the method 800 is referred to herein as a “processing device.”

In block 802, the processing device may decrypt the user and/or enterprise data using the verify encryption seed key. As described, user and/or enterprise data stored in a memory of a computing device may be encrypted for protection of the user and/or enterprise data by using an encryption seed key. The computing device may store the encryption seed key. The processing device may decrypt the sealed encryption seed key to produce the verify encryption seed key. When properly configured, the verify encryption seed key may be the same as the enroll encryption seed key, and may be used with a data decrypting algorithm to decrypt the user and/or enterprise data for use by various components and functions of the computing device. However, when the verify encryption seed key is not properly configured (i.e., does not correspond with the enroll encryption seed key used to encrypt the user and/or enterprise data), the encrypted user and/or enterprise data may not be properly decrypted, thus rendering the data incomprehensible to the computing device.

In block 804, the processing device may execute a function using the user and/or enterprise data. Once properly decrypted, the user and/or enterprise data may be accessed by the processing device and used to implement functions of the computing device. Said another way, properly decrypted user and/or enterprise data may enable the processing device to execute a function in a predictable manner with a predictable outcome. Improperly decrypted user and/or enterprise data, specifically data decrypted using an incorrect verify encryption seed key, may or may not allow the processing device to execute a particular function. For example, the processing device may execute a function, but the function may produce an unpredictable and undesired outcome. As another example, the processing device may attempt to execute the function, but the function may respond by denying and/or interrupting execution of the function using incorrect, improperly decrypted user and/or enterprise data.

In optional block 806, the processing device may issue a fatal error in response to execution using user and/or enterprise data decrypted using an incorrect encryption seed key.

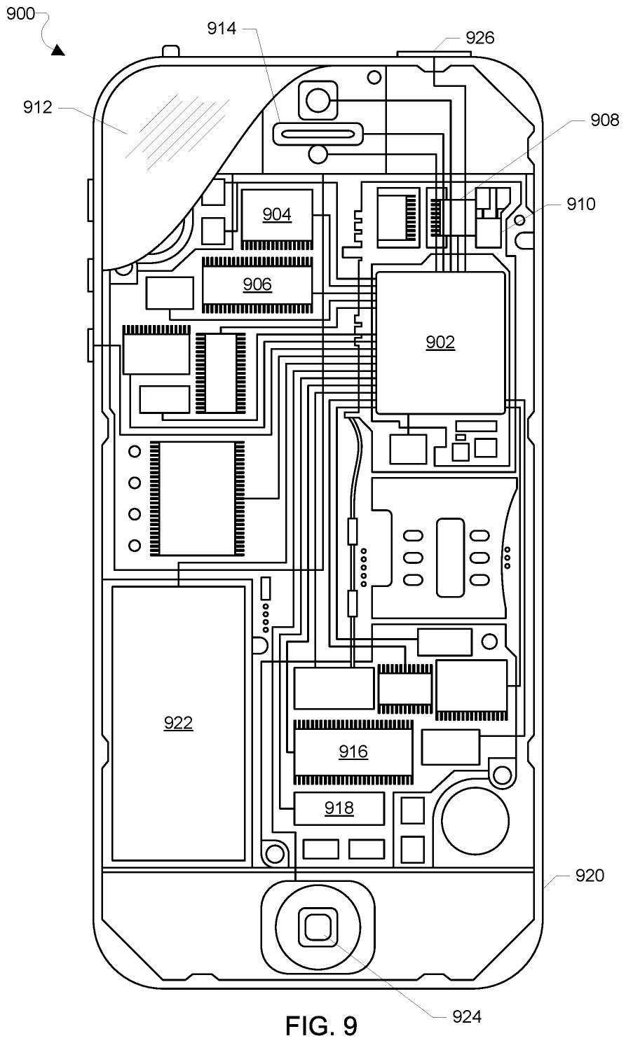

The various embodiments (including, but not limited to, embodiments described above with reference to FIGS. 1-8) may be implemented in a wide variety of computing systems including mobile computing devices, an example of which suitable for use with the various embodiments is illustrated in FIG. 9. The mobile computing device 900 may include a processor 902 coupled to a touchscreen controller 904 and an internal memory 906. The processor 902 may be one or more multicore integrated circuits designated for general or specific processing tasks. The internal memory 906 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the mobile computing device 900 need not have touch screen capability.

The mobile computing device 900 may have one or more radio signal transceivers 908 (e.g., Peanut, Bluetooth, ZigBee, Wi-Fi, RF radio) and antennae 910, for sending and receiving communications, coupled to each other and/or to the processor 902. The transceivers 908 and antennae 910 may be used with the above-mentioned circuitry to implement the various wireless transmission protocol stacks and interfaces. The mobile computing device 900 may include a cellular network wireless modem chip 916 that enables communication via a cellular network and is coupled to the processor.

The mobile computing device 900 may include a peripheral device connection interface 918 coupled to the processor 902. The peripheral device connection interface 918 may be singularly configured to accept one type of connection or may be configured to accept various types of physical and communication connections, common or proprietary, such as Universal Serial Bus (USB), FireWire, Thunderbolt, or PCIe. The peripheral device connection interface 918 may also be coupled to a similarly configured peripheral device connection port (not shown).

The mobile computing device 900 may also include speakers 914 for providing audio outputs. The mobile computing device 900 may also include a housing 920, constructed of a plastic, metal, or a combination of materials, for containing all or some of the components described herein. The mobile computing device 900 may include a power source 922 coupled to the processor 902, such as a disposable or rechargeable battery. The rechargeable battery may also be coupled to the peripheral device connection port to receive a charging current from a source external to the mobile computing device 900. The mobile computing device 900 may also include a physical button 924 for receiving user inputs. The mobile computing device 900 may also include a power button 926 for turning the mobile computing device 900 on and off.

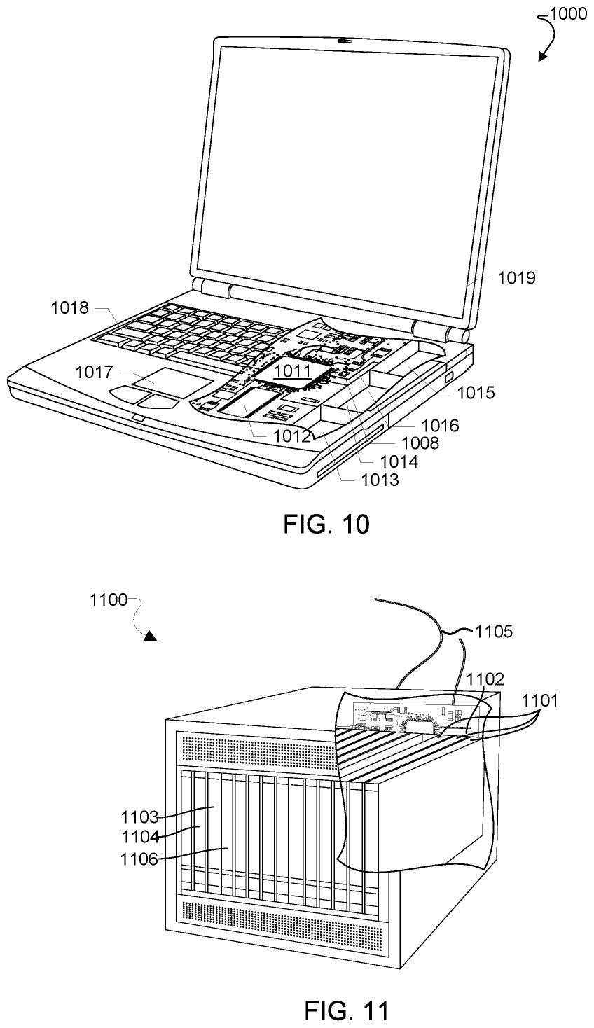

The various embodiments (including, but not limited to, embodiments described above with reference to FIGS. 1-8) may be implemented in a wide variety of computing systems include a laptop computer 1000 an example of which is illustrated in FIG. 10. Many laptop computers include a touchpad touch surface 1017 that serves as the computer's pointing device, and thus may receive drag, scroll, and flick gestures similar to those implemented on computing devices equipped with a touch screen display and described above. A laptop computer 1000 will typically include a processor 1011 coupled to volatile memory 1012 and a large capacity nonvolatile memory, such as a disk drive 1013 of Flash memory. Additionally, the computer 1000 may have one or more antenna 1008 for sending and receiving electromagnetic radiation that may be connected to a wireless data link and/or cellular telephone transceiver 1016 coupled to the processor 1011. The computer 1000 may also include a floppy disc drive 1014 and a compact disc (CD) drive 1015 coupled to the processor 1011. In a notebook configuration, the computer housing includes the touchpad 1017, the keyboard 1018, and the display 1019 all coupled to the processor 1011. Other configurations of the computing device may include a computer mouse or trackball coupled to the processor (e.g., via a USB input) as are well known, which may also be used in conjunction with the various embodiments.

The various embodiments (including, but not limited to, embodiments described above with reference to FIGS. 1-8) may also be implemented in fixed computing systems, such as any of a variety of commercially available servers. An example server 1100 is illustrated in FIG. 11. Such a server 1100 typically includes one or more multicore processor assemblies 1101 coupled to volatile memory 1102 and a large capacity nonvolatile memory, such as a disk drive 1104. As illustrated in FIG. 11, multicore processor assemblies 1101 may be added to the server 1100 by inserting them into the racks of the assembly. The server 1100 may also include a floppy disc drive, compact disc (CD) or digital versatile disc (DVD) disc drive 1106 coupled to the processor 1101. The server 1100 may also include network access ports 1103 coupled to the multicore processor assemblies 1101 for establishing network interface connections with a network 1105, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for protecting data by preventing non-authorized firmware modification on a computing device, comprising:
measuring, by a processing device executing a software program, an image of a firmware update to produce a measurement of the image of the firmware update;
modifying, by the processing device, a version identifier of a prior installed firmware producing a version identifier of the firmware update;
applying, by the processing device, a root key generation algorithm to the measurement of the image of the firmware update, the version identifier of the firmware update, and an enroll identity credential;
generating, by the processing device, an enroll encryption root key as an output of the root key generation algorithm;
applying, by the processing device, a seed key encryption algorithm to the enroll encryption root key and an enroll encryption seed key; and
generating, by the processing device, a sealed encryption seed key as an output of the seed key encryption algorithm.

2. The method of claim 1, further comprising:
receiving, by the processing device, the version identifier of the prior installed firmware from a hardware memory of the computing device; and
storing the version identifier of the firmware update to the hardware memory as a version identifier of a current installed firmware.

3. The method of claim 2, further comprising:
measuring, by a hardware component, an image of the current installed firmware producing a measurement of the image of the current installed firmware;
applying, by the processing device, the root key generation algorithm to the measurement of the image of the current installed firmware, the version identifier of the current installed firmware, and a verify identity credential;
generating, by the processing device, a verify encryption root key as an output of the root key generation algorithm;
applying, by the processing device, a seed key decryption algorithm to the verify encryption root key and the sealed encryption seed key; and
generating, by the processing device, a verify encryption seed key as an output of the seed key decryption algorithm, wherein the enroll encryption seed key is the same as the verify encryption seed key for the measurement of the image of the firmware update being the same as the measurement of the image of the current installed firmware, the version identifier of the firmware update being the same as the version identifier of the current installed firmware, and the enroll identity credential being the same as the verify identity credential.

4. The method of claim 3, further comprising decrypting data using the verify encryption seed key that is the same as the enroll encryption seed key.

5. The method of claim 3, wherein:
the verify identity credential comprises at least one of a user credential and an enterprise credential; and
applying a root key generation algorithm to the measurement of the image of the current installed firmware, the version identifier of the current installed firmware, and a verify identity credential comprises applying the root key generation algorithm to the measurement of the image of the current installed firmware, the version identifier of the current installed firmware, the verify identity credential, and at least one of a unique label, a secure user identifier, and a hardware unique key.

6. The method of claim 1, further comprising receiving an update signal,
wherein applying a root key generation algorithm to the measurement of the image of the firmware update, the version identifier of the firmware update, and an enroll identity credential occurs in response to receiving the update signal.

7. The method of claim 1, further comprising exposing the enroll encryption root key only to a secure component of the computing device.

8. The method of claim 1, wherein:
the enroll identity credential comprises at least one of a user credential and an enterprise credential; and
applying a root key generation algorithm to the measurement of the image of the firmware update, the version identifier of the firmware update, and an enroll identity credential comprises applying the root key generation algorithm to the measurement of the image of the firmware update, the version identifier of the firmware update, the enroll identity credential, and at least one of a unique label, a secure user identifier, and a hardware unique key.

9. A computing device comprising:
a processor configured with processor-executable instructions to cause the processor to perform operations comprising:
measuring, by execution of a software program, an image of a firmware update to produce a measurement of the image of the firmware update;
modifying a version identifier of a prior installed firmware producing a version identifier of the firmware update;
applying a root key generation algorithm to the measurement of the image of the firmware update, the version identifier of the firmware update, and an enroll identity credential;
generating an enroll encryption root key as an output of the root key generation algorithm;
applying a seed key encryption algorithm to the enroll encryption root key and an enroll encryption seed key; and
generating a sealed encryption seed key as an output of the seed key encryption algorithm.

10. The computing device of claim 9, further comprising a hardware memory communicatively connected to the processor,
wherein the processor is configured with processor-executable instructions to perform operations further comprising:
receiving the version identifier of the prior installed firmware from the hardware memory; and
storing the version identifier of the firmware update to the hardware memory as a version identifier of a current installed firmware.

11. The computing device of claim 10, further comprising a hardware component communicatively connected to the processor, wherein the hardware component is configured to measure an image of the current installed firmware producing a measurement of the image of the current installed firmware,
wherein the processor is configured with processor-executable instructions to perform operations further comprising:
applying the root key generation algorithm to the measurement of the image of the current installed firmware, the version identifier of the current installed firmware, and a verify identity credential;
generating a verify encryption root key as an output of the root key generation algorithm;
applying a seed key decryption algorithm to the verify encryption root key and the sealed encryption seed key; and
generating a verify encryption seed key as an output of the seed key decryption algorithm, wherein the enroll encryption seed key is the same as the verify encryption seed key for the measurement of the image of the firmware update being the same as the measurement of the image of the current installed firmware, the version identifier of the firmware update being the same as the version identifier of the current installed firmware, and the enroll identity credential being the same as the verify identity credential.

12. The computing device of claim 11, wherein the processor is configured with processor-executable instructions to perform operations further comprising decrypting data using the verify encryption seed key that is the same as the enroll encryption seed key.

13. The computing device of claim 11, wherein:
the verify identity credential comprises at least one of a user credential and an enterprise credential; and
the processor is configured with processor-executable instructions to perform operations such that applying a root key generation algorithm to the measurement of the image of the current installed firmware, the version identifier of the current installed firmware, and a verify identity credential comprises applying the root key generation algorithm to the measurement of the image of the current installed firmware, the version identifier of the current installed firmware, the verify identity credential, and at least one of a unique label, a secure user identifier, and a hardware unique key.

14. The computing device of claim 9, wherein:
the processor is configured with processor-executable instructions to perform operations further comprising receiving an update signal; and
the processor is configured with processor-executable instructions to perform operations such that applying a root key generation algorithm to the measurement of the image of the firmware update, the version identifier of the firmware update, and an enroll identity credential occurs in response to receiving the update signal.

15. The computing device of claim 9, wherein the processor is configured with processor-executable instructions to perform operations further comprising exposing the enroll encryption root key only to a secure component of the computing device.

16. The computing device of claim 9, wherein:
the enroll identity credential comprises at least one of a user credential and an enterprise credential; and
the processor is configured with processor-executable instructions to perform operations such that applying a root key generation algorithm to the measurement of the image of the firmware update, the version identifier of the firmware update, and an enroll identity credential comprises applying the root key generation algorithm to the measurement of the image of the firmware update, the version identifier of the firmware update, the enroll identity credential, and at least one of a unique label, a secure user identifier, and a hardware unique key.

17. A computing device, comprising:
means for measuring an image of a firmware update to produce a measurement of the image of the firmware update;
means for modifying a version identifier of a prior installed firmware producing a version identifier of the firmware update;
means for applying a root key generation algorithm to the measurement of the image of the firmware update, the version identifier of the firmware update, and an enroll identity credential;
means for generating an enroll encryption root key as an output of the root key generation algorithm;
means for applying a seed key encryption algorithm to the enroll encryption root key and an enroll encryption seed key; and
means for generating a sealed encryption seed key as an output of the seed key encryption algorithm.

18. The computing device of claim 17, further comprising:
means for receiving the version identifier of the prior installed firmware from a hardware memory of the computing device; and
means for storing the version identifier of the firmware update to the hardware memory as a version identifier of a current installed firmware.

19. The computing device of claim 18, further comprising:
means for measuring an image of the current installed firmware producing a measurement of the image of the current installed firmware;
means for applying the root key generation algorithm to the measurement of the image of the current installed firmware, the version identifier of the current installed firmware, and a verify identity credential;
means for generating a verify encryption root key as an output of the root key generation algorithm;
means for applying a seed key decryption algorithm to the verify encryption root key and the sealed encryption seed key; and
means for generating a verify encryption seed key as an output of the seed key decryption algorithm, wherein the enroll encryption seed key is the same as the verify encryption seed key for the measurement of the image of the firmware update being the same as the measurement of the image of the current installed firmware, the version identifier of the firmware update being the same as the version identifier of the current installed firmware, and the enroll identity credential being the same as the verify identity credential.

20. The computing device of claim 19, further comprising means for decrypting data using the verify encryption seed key that is the same as the enroll encryption seed key.

21. The computing device of claim 19, wherein:
the verify identity credential comprises at least one of a user credential and an enterprise credential;
means for applying a root key generation algorithm to the measurement of the image of the current installed firmware, the version identifier of the current installed firmware, and a verify identity credential comprises means for applying the root key generation algorithm to the measurement of the image of the current installed firmware, the version identifier of the current installed firmware, the verify identity credential, and at least one of a unique label, a secure user identifier, and a hardware unique key;
the enroll identity credential comprises at least one of a user credential and an enterprise credential; and
means for applying a root key generation algorithm to the measurement of the image of the firmware update, the version identifier of the firmware update, and an enroll identity credential comprises means for applying the root key generation algorithm to the measurement of the image of the firmware update, the version identifier of the firmware update, the enroll identity credential, and at least one of a unique label, a secure user identifier, and a hardware unique key.

22. The computing device of claim 17, further comprising means for receiving an update signal,
wherein means for applying a root key generation algorithm to the measurement of the image of the firmware update, the version identifier of the firmware update, and an enroll identity credential comprises means for applying the root key generation algorithm to the measurement of the image of the firmware update, the version identifier of the firmware update, and the enroll identity credential in response to receiving the update signal.

23. The computing device of claim 17, further comprising means for exposing the enroll encryption root key only to a secure component of the computing device.

24. A non-transitory processor-readable storage medium having stored thereon processor-executable instructions configured to cause a processor of a computing device to perform operations comprising:
measuring an image of a firmware update to produce a measurement of the image of the firmware update;
modifying a version identifier of a prior installed firmware producing a version identifier of the firmware update;
applying a root key generation algorithm to the measurement of the image of the firmware update, the version identifier of the firmware update, and an enroll identity credential;
generating an enroll encryption root key as an output of the root key generation algorithm;
applying a seed key encryption algorithm to the enroll encryption root key and an enroll encryption seed key; and
generating a sealed encryption seed key as an output of the seed key encryption algorithm.

25. The non-transitory processor-readable storage medium of claim 24, wherein the stored processor-executable instructions are configured to cause the processor of the computing device to perform operations further comprising:
receiving the version identifier of the prior installed firmware from a hardware memory of the computing device; and
storing the version identifier of the firmware update to the hardware memory as a version identifier of a current installed firmware.

26. The non-transitory processor-readable storage medium of claim 25, wherein the stored processor-executable instructions are configured to cause the processor of the computing device to perform operations further comprising:
measuring an image of the current installed firmware producing a measurement of the image of the current installed firmware;
applying the root key generation algorithm to the measurement of the image of the current installed firmware, the version identifier of the current installed firmware, and a verify identity credential;
generating a verify encryption root key as an output of the root key generation algorithm;
applying a seed key decryption algorithm to the verify encryption root key and the sealed encryption seed key; and
generating a verify encryption seed key as an output of the seed key decryption algorithm, wherein the enroll encryption seed key is the same as the verify encryption seed key for the measurement of the image of the firmware update being the same as the measurement of the image of the current installed firmware, the version identifier of the firmware update being the same as the version identifier of the current installed firmware, and the enroll identity credential being the same as the verify identity credential.

27. The non-transitory processor-readable storage medium of claim 26, wherein the stored processor-executable instructions are configured to cause the processor of the computing device to perform operations further comprising decrypting data using the verify encryption seed key that is the same as the enroll encryption seed key.

28. The non-transitory processor-readable storage medium of claim 26, wherein:
the verify identity credential comprises at least one of a user credential and an enterprise credential;
the enroll identity credential comprises at least one of a user credential and an enterprise credential; and
the stored processor-executable instructions are configured to cause the processor of the computing device to perform operations such that:
applying a root key generation algorithm to the measurement of the image of the current installed firmware, the version identifier of the current installed firmware, and a verify identity credential comprises applying the root key generation algorithm to the measurement of the image of the current installed firmware, the version identifier of the current installed firmware, the verify identity credential, and at least one of a unique label, a secure user identifier, and a hardware unique key; and
applying a root key generation algorithm to the measurement of the image of the firmware update, the version identifier of the firmware update, and an enroll identity credential comprises applying the root key generation algorithm to the measurement of the image of the firmware update, the version identifier of the firmware update, the enroll identity credential, and at least one of a unique label, a secure user identifier, and a hardware unique key.

29. The non-transitory processor-readable storage medium of claim 24, wherein the stored processor-executable instructions are configured to cause the processor of the computing device to perform operations further comprising receiving an update signal,
wherein applying a root key generation algorithm to the measurement of the image of the firmware update, the version identifier of the firmware update, and an enroll identity credential occurs in response to receiving the update signal.

30. The non-transitory processor-readable storage medium of claim 24, wherein the stored processor-executable instructions are configured to cause the processor of the computing device to perform operations further comprising exposing the enroll encryption root key only to a secure component of the computing device.
